(19) United States
(12) Patent Application Publication
(10) Pub. No.: US 2014/0122163 A1
(43) Pub. Date: May 1, 2014

(54) EXTERNAL OPERATIONAL RISK ANALYSIS

(71) Applicant: BANK OF AMERICA CORPORATION, Charlotte, NC (US)

(72) Inventors: Richard Warren Simpson, Lancaster, SC (US); Mary Kathleen Riley, Denver, NC (US)

(73) Assignee: Bank of America Corporation, Charlotte, NC (US)

(21) Appl. No.: 13/664,888

(22) Filed: Oct. 31, 2012

(51) Int. Cl. G06Q 10/06

(52) U.S. Cl. 705/7.28

(57) ABSTRACT

Analyzing external operational risk comprises receiving data associated with an organization from a data source over a network. Data associated with a plurality of third parties is received from a plurality of data sources over the network. A processor categorizes the organization data and the third party data according to operational risk categories and analyzes the categorized organization data and the third party data. A report is created based on the analysis and communicated to a computer.

### TECHNICAL FIELD OF THE INVENTION

This invention relates generally to risk analysis, and more particularly to external operational risk analysis.

### BACKGROUND OF THE INVENTION

Organizations analyze data to reduce the level of risk that may impact the organization. Organizations may analyze internal, structured data to determine potential risk. However, analyzing only internal, structured data does not provide a full risk analysis for the organization's use.

### SUMMARY OF THE INVENTION

According to embodiments of the present disclosure, disadvantages and problems associated with external operational risk analysis may be reduced or eliminated.

In certain embodiments, analyzing external operational risk comprises receiving data associated with an organization from a data source over a network. Data associated with a plurality of third parties is received from a plurality of data sources over the network. A processor categorizes the organization data and the third party data according to operational risk categories and analyzes the categorized organization data and the third party data. A report is created based on the analysis and communicated to a computer.

Certain embodiments of the present disclosure may provide one or more technical advantages. A technical advantage of one embodiment includes providing a system that facilitates the analysis of unstructured operational risk data for organizations. Having the ability to analyze unstructured operational risk data allows for a broader risk analysis. Another technical advantage of an embodiment includes analyzing unstructured data that is internal to the organization and analyzing unstructured data that is external to the organization. Again, broadening the scope of the analysis allows the organization to better understand potential risks and respond accordingly. Yet another technical advantage includes electronically gathering information from electronic data sources to provide current information regarding the external organizations to provide more complete and accurate information for the risk analysis.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of an embodiment of a system for external operational risk analysis;

FIG. 2 illustrates a flowchart for external operational risk analysis;

FIG. 3 illustrates a screenshot that provides information regarding a third party gathered from an internal source; and

FIG. 4 illustrates a screenshot that provides information regarding a third party gathered from a source external to the organization.

### DETAILED DESCRIPTION OF THE INVENTION

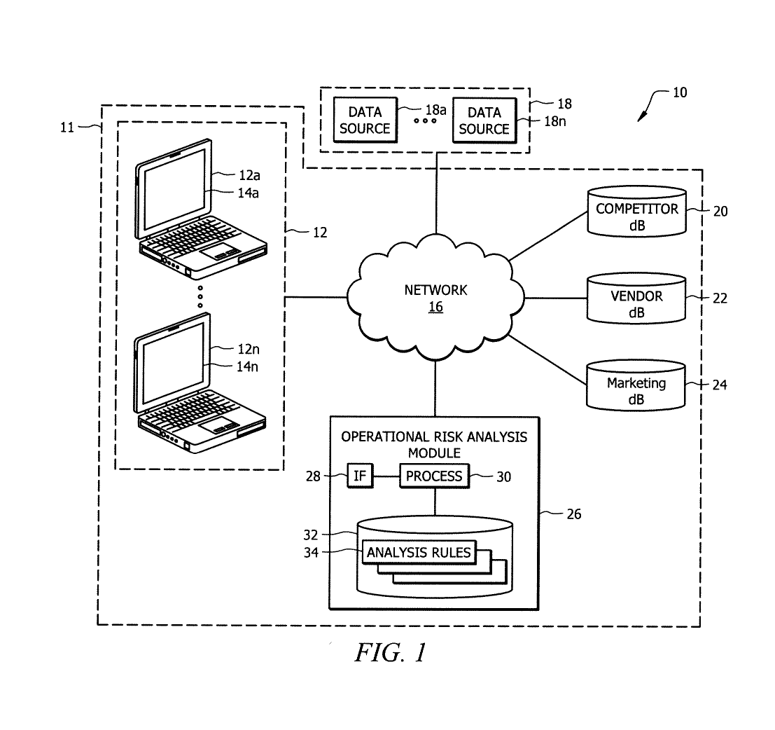

Embodiments of the present invention and its advantages are best understood by referring to FIGS. 1 through 4 of the drawings, like numerals being used for like and corresponding parts of the various drawings.

Governmental entities have established certain regulatory expectations for organizations, particularly financial institutions, to develop external risk identification processes to improve forward looking and predictive risk analysis. These expectations includes generating results that are structured to fit risk categories established by the Basel Committee on Banking Supervision. Currently, organizations focus their external data compilation on external operational monetary losses, which are compiled in structured data formats that can be consistently quantified and reported. Structured data represents data that is identifiable because it is organized in a structure with consistent and recurring patterns. Unstructured data represents data that has no identifiable structure or consistent and recurring patterns. For example, unstructured data may include substantial text, which results in irregularities and ambiguities that make it difficult for a computer to understand. Therefore, a system and method is needed to compile external and internal unstructured data, in addition to the structured data, and to analyze the unstructured data based on operational risk categories.

FIG. 1 illustrates a block diagram of an embodiment of a system 10 for external operational risk analysis. System 10 includes computers 12, data sources 18, a competitor database 20, a vendor database 22, and a marketing database 24 that communicate over one or more networks 16 with operational risk analysis module 26 to facilitate the process of selecting, locating, scanning, filtering, structuring, and compiling unstructured and structured data related to external operational risks. System 10 implements a filtering and alignment approach on information related to organization 11 and related to third parties that is based on Basel regulatory definitions, which drives categorical risk analysis. The unstructured, compiled data is structured to meet external regulatory expectations and to use for internal applications to facilitate effective and proactive risk identification.

In the illustrated embodiment, organization 11 comprises computers 12, competitor database 20, vendor database 22, marketing database 24, and operational risk analysis module 26. Organization 11 represents an entity in any suitable industry that manages risk. Organization 11 may include companies of any suitable size that evaluate operational risk to manage and identify risk of the organization. Third parties may include any suitable entity that is external to organization 11, such as vendors of organization 11, competitors of organization 11, or entities in industries different from organization 11, such as technology companies or other companies that regularly use the Internet.

System 10 includes computers 12a-12n, where n represents any suitable number, that communicate with operational risk analysis module 26 through network 16. For example, computer 12 communicates with operational risk analysis module 26 to identify the sources from which to compile unstructured data. As another example, computers 12 receive analyzed data from operational risk analysis module 26. Computer 12 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Computer 12 may also comprise a user interface, such as a display, keyboard, mouse, or other appropriate terminal equipment. In the illustrated embodiment, computer 12 includes a graphical user interface (“GUI”) 14 that displays information received from operational risk analysis module 26. For example, GUI 14 may display analyzed external data in a particular format to a user of computer 12. GUI 14 is generally operable to tailor and filter data entered by and presented to the user. GUI 14 may provide the user with an efficient and user-friendly presentation of information using a plurality of displays having interactive fields, pull-down lists, and buttons operated by the user. GUI 14 may include multiple levels of abstraction including groupings and boundaries. It should be understood that the term GUI 14 may be used in the singular or in the plural to describe one or more GUIs 14 in each of the displays of a particular GUI 14.

Network 16 represents any suitable network operable to facilitate communication between the components of system 10, such as computers 12, data sources 18, competitor database 20, vendor database 22, marketing database 24, and operational risk analysis module 26. Network 16 may include any interconnecting system capable of transmitting audio, video, signals, data, messages, or any combination of the preceding. Network 16 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Data sources 18 represent components that are external to organization 11 that provide unstructured data associated with organization 11 and/or third parties to operational risk analysis module 26. Data sources 18 may provide unbiased, independent information for analysis. For example, data source 18 may include regulatory filings associated with third parties or organization 11, such as filings made with the Security Exchange Commission (e.g., 10Ks and 10Qs). Data source 18 may also include press releases, news, events, or any other digital media that may be related to organization 11 or a third party. Additionally, data sources 18 may include independent professional research materials. In an embodiment, data sources 18 are chosen based on the maximum potential to identify external operational risks based on unstructured data content and searchable databases. Therefore, data sources 18 are scanned for targeted, repeatable information. In an exemplary embodiment, data sources 18 provide information associated with industry competitors of organization 11; information regarding new and emerging products and/or technologies; information regarding legal, regulatory, and/or geopolitical trends; major suppliers for organization 11 and its industry competitors; and competitors and/or potential competitors in different industries.

Data sources 18 may include a network server, any suitable remote server, a mainframe, a host computer, a workstation, a web server, a personal computer, a file server, or any other suitable device operable to communicate with other components in system 10 and process data. In some embodiments, data source 18 may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of data source 18 may be performed by any suitable combination of one or more servers or other components at one or more locations. In the embodiment where the module is a server, the server may be a private server, and the server may be a virtual or physical server. Also, data source 18 may include any suitable component that functions as a server.

Competitor database 20 stores, either permanently or temporarily, information associated with competitors of organization 11. Competitor database 20 is within organization 11 and represents information that organization 11 compiles associated with its competitors. The information stored in competitor database 20 may include, but is not limited to, press release information, regulatory filing information, professional research materials, or other suitable competitor analysis information. Operational risk analysis module 26 may communicate with competitor database 20 to receive information associated with competitors of organization 11. Competitor database 20 includes any one or a combination of volatile or non-volatile local or remote devices suitable for storing information. For example, competitor database 20 may include Random Access Memory (RAM), Read Only Memory (ROM), magnetic storage devices, optical storage devices, or any other suitable information storage device or combination of these devices.

Vendor database 22 stores, either permanently or temporarily, information associated with vendors of organization 11. Vendor database 22 is within organization 11 and represents information that organization 11 compiles associated with its vendors. The information stored in vendor database 22 may include, but is not limited to, press release information, regulatory filing information, professional research materials, performance information, relationship information, financial data, or other suitable vendor analysis information. Operational risk analysis module 26 may communicate with vendor database 22 to receive information associated with vendors of organization 11. Vendor database 22 includes any one or a combination of volatile or non-volatile local or remote devices suitable for storing information. For example, vendor database 22 may include RAM, ROM, magnetic storage devices, optical storage devices, or any other suitable information storage device or combination of these devices.

Marketing database 24 stores, either permanently or temporarily, information associated with organization 11 or other third parties. Marketing database 24 is within organization 11 and represents information that organization 11 compiles regarding itself and third parties. For example, marketing database 24 stores information on third parties that are not currently vendors or competitors, but which have potential to become collaborators, competitors, or to create a competitive threat in the future. The information stored in marketing database 24 may include, but is not limited to, press release information, regulatory filing information, professional research materials, or other suitable marketing information. Operational risk analysis module 26 may communicate with marketing database 24 to receive information associated with organization 11. Marketing database 24 includes any one or a combination of volatile or non-volatile local or remote devices suitable for storing information. For example, marketing database 24 may include RAM, ROM, magnetic storage devices, optical storage devices, or any other suitable information storage device or combination of these devices.

Operational risk analysis module 26 represents any suitable component that facilitates the analysis of external and internal risks. Operational risk analysis module 26 receives data from data sources 18, competitor database 20, vendor database 22, and/or marketing database 24 and analyzes the received data to identify operational risks of organization 11. In an embodiment, operational risk analysis module 26 receives unstructured data from the various sources to analyze. Additionally, operational risk analysis module 26 may create reports based on the analysis, and may communicate the reports to computer 12.

Operational risk analysis module 26 may include a network server, any suitable remote server, a mainframe, a host computer, a workstation, a web server, a personal computer, a file server, or any other suitable device operable to communicate with computers 12, data sources 18, competitor database 20, vendor database 22, and/or marketing database 24. In some embodiments, operational risk analysis module 26 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of operational risk analysis module 26 may be performed by any suitable combination of one or more servers or other components at one or more locations. In the embodiment where operational risk analysis module 26 is a server, the server may be a private server, or the server may be a virtual or physical server. The server may include one or more servers at the same or remote locations. Also, operational risk analysis module 26 may include any suitable component that functions as a server. In the illustrated embodiment, operational risk analysis module 26 includes a network interface 28, a processor 30, and a memory 32.

Network interface 28 represents any suitable device operable to receive information from network 16, transmit information through network 16, perform processing of information, communicate with other devices, or any combination of the preceding. For example, network interface 28 receives competitor information from competitor database 20. As another example, network interface 28 receives information external to organization 11 from data sources 18. As yet another example, network interface 28 may communicate reports based on the analysis of the received data to computers 12. Network interface 28 represents any port or connection, real or virtual, including any suitable hardware and/or software, including protocol conversion and data processing capabilities, to communicate through a LAN, WAN, MAN, or other communication system that allows operational risk analysis module 26 to exchange information with network 16, data sources 18, competitor database 20, vendor database 22, marketing database 24, or other components of system 10.

Processor 30 communicatively couples to network interface 28 and memory 32, and controls the operation and administration of operational risk analysis module 26 by processing information received from network interface 28 and memory 32. Processor 30 includes any hardware and/or software that operates to control and process information. For example, processor 30 executes analysis rules 34 to control the operation of operational risk analysis module 26. Processor 30 may be a programmable logic device, a microcontroller, a microprocessor, any suitable processing device, or any suitable combination of the preceding.

Memory 32 stores, either permanently or temporarily, data, operational software, or other information for processor 30. Memory 32 includes any one or a combination of volatile or non-volatile local or remote devices suitable for storing information. For example, memory 32 may include RAM, ROM, magnetic storage devices, optical storage devices, or any other suitable information storage device or a combination of these devices. In the illustrated embodiment, memory 32 includes analysis rules 34.

Analysis rules 34 generally refer to logic, rules, algorithms, code, tables, and/or other suitable instructions embodied in a computer-readable storage medium for performing the described functions and operations of operational risk analysis module 26. For example, rules 34 facilitate the analysis of data received by operational risk analysis module 26. In an embodiment, rules 34 facilitate the categorization of the received data into operational risk categories. Additionally, rules 34 may facilitate sorting analyzed data into temporal groups. While illustrated as including a particular module, memory 32 may include any suitable information for use in the operation of operational risk analysis module 26.

In an exemplary embodiment of operation, operational risk analysis module 26 receives data that is internal to organization 11 and data that is external to organization 11. Operational risk analysis module 26 may receive data internal to organization 11 from competitor database 20, vendor database 22, and/or marketing database 24. Operational risk analysis module 26 may receive data external to organization 11 from data sources 18. In an embodiment, the internal and external data may include unstructured data regarding organization 11 and/or third parties.

After receiving the data to analyze, operational risk analysis module 26 categorizes the received data according to operational risk categories. The operational risk categories include fraud and criminal, human malicious external events, human non-malicious external events, natural events and disasters, third party and vendor, legal, and regulatory and governmental. Once operational risk analysis module 26 categorizes the data, the data is tagged with the source information. Operational risk analysis module 26 may then compile the data according to the source information and analyzes the data according to the source tags and operational risk categories. Upon completion of the analysis, operational risk analysis module 26 sorts the analyzed data into temporal groups. A report can be created with the analyzed data and communicated to computers 12 for further use within organization 11.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may include any number of computers 12, data sources 18, competitor databases 20, vendor databases 22, marketing databases 24, and operational risk analysis modules 26. As another example, organization 11 may include an organization credit risk database, which includes information regarding risk factors that organization 11 has in different countries. Any suitable logic may perform the functions of system 10 and the components within system 10.

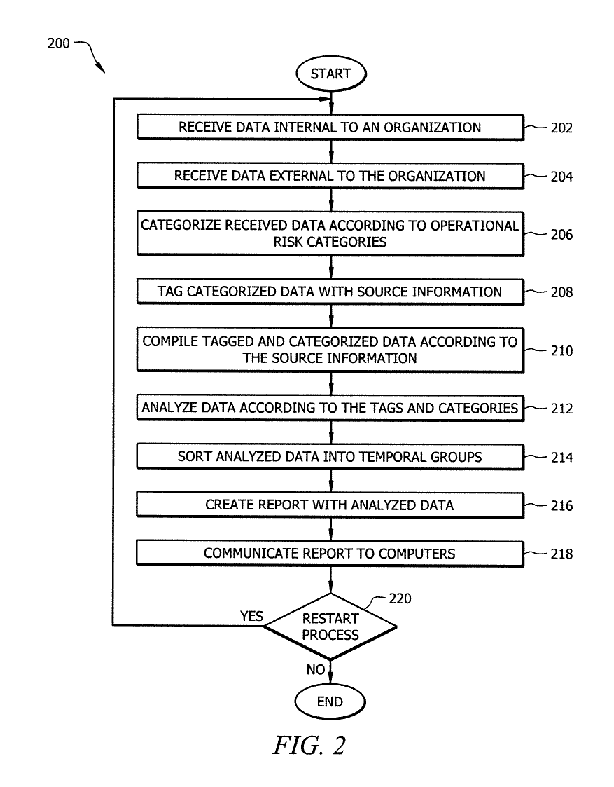

FIG. 2 illustrates a flowchart 200 for external operational risk analysis. At step 202, operational risk analysis module 26 receives data internal to organization 11. The data internal to organization 11 may be received from any suitable source that is within organization 11, such as competitor database 20, vendor database 22, and/or marketing database 24. The information that is internal to organization 11 may be related to organization 11 and/or third parties. For example, organization 11 may compile information associated with its vendors. As another example, organization 11 may compile information associated with its competitors. The data that is internal to organization 11 may include unstructured data.

At step 204, operational risk analysis module 26 receives data external to organization 11. The data external to organization 11 may be received from any suitable source that is outside of organization 11, such as data sources 18. The external data may represent repeatable information. In an embodiment, the data external to organization 11 includes unstructured data. The data may represent information from regulatory filings, digital media (e.g., news, events, press releases, blogs), and/or independent profession research materials.

At step 206, operational risk analysis module 26 categorizes the received data according to operational risk categories. In an embodiment, the operational risk categories are based on the Basel regulatory definitions. For example, operational risk categories may include the following: fraud and criminal, human malicious external events, human non-malicious external events, natural events and disasters, third party and vendor, legal, and regulatory and governmental. To categorize the received data, operational risk analysis module 26 uses Boolean key words, word strings, and/or logical relationships among search terms. The data may relate to one or more categories and may be classified accordingly.

Operational risk analysis module 26 may use any suitable key word, word string, and/or logical relationship among search terms to categorize the data. For example, to categorize data as fraud and criminal, the data may relate to cyber security breaches; computer viruses; malicious code; phishing attacks; cyber attacks on networks, systems, or devices used by customers; sudden increases in customer transaction volume; or other suitable event that may be considered fraud and criminal. As another example, to categorize data as human malicious external events, the data may relate to cyber attacks, disruption or failure in physical infrastructure, release or misuse of confidential proprietary information, information security data breaches, or other suitable event that may be considered a human malicious external event. To categorize data as human non-malicious external events, the data may relate to a disease pandemic or public health crisis; electrical or telecommunications outages; changes in the supply, demand, or availability of natural resources; rapid emergence of new technologies, products, or services; shortages in natural resources; or other suitable event that may be considered a human non-malicious external event. With respect to natural events and disasters, data may be classified in this category if it relates to a natural disaster, a weather related event, a large scale environmental contamination issue, or other natural event or disaster.

To categorize data as third party and vendor, the data may relate to third party operational failure, termination, or capacity constrains; technology failure or disruption instituted by counterparties; limitations on continued and unimpeded access to the Internet; insolvency or financial instability of outsourcing partners or suppliers; dependency on a single or a limited number of suppliers; skilled labor shortages; potential for widespread performance problems with Internet communications; or other suitable event that may be considered third party and vendor. To categorize data as legal, the data may relate to exposure to lawsuits, uncertain and evolving laws and regulatory requirements, country laws and business practices that favor local competitors, reduced protection for intellectual property rights in some countries, class action lawsuits, or other suitable issue that may be considered legal. To categorize data as regulatory and governmental, the data may relate to geopolitical uncertainty, restrictive governmental actions, government regulations on e-commerce, changes in regulations or enforcement regarding consumer privacy and protection of user data, failure to acquire adequate regulated network and wireless spectrum licensing rights, degradation in Internet performance, delays and inefficiencies in operations due to country imposed travel restrictions, or other suitable issue that may be considered regulatory and governmental.

At step 208, operational risk analysis module 26 tags the categorized data with source information. This facilitates the development of a second level of structured compilation, wherein the first level is the categorization based on operational risk categories. The data may be tagged with any suitable source information, which may include the following tags: competitor; new and emerging product/technology; legal, regulatory, and geopolitical trends; supplier; and non-industry competitor/potential competitor. The tagged, categorized data is compiled according to the source information in step 210.

At step 212, the data is analyzed according to the tags and categories. In analyzing the data, a weighting factor may be applied based on several criteria, which include, but are not limited to, the source and frequency of the risk identification occurring, thematic data content congruence across the data sources, the integrity of information from a source (with a priority on a regulatory perspective), the quality of content associated with a particular source, the timeliness of the source and the currency of the available information, and/or the critical mass of key word matches based on key word selection. At step 214, operational risk analysis module 26 sorts the analyzed data into temporal groups. For example, the data may be sorted into the following groups based on a temporal perspective: realized (i.e., historical) risks, current risks, emerging or forecasted risks, or potential future risks that are not yet adequately defined or understood.

Now that the data has been grouped based on operational risk categories, tagged with the source information, analyzed based on the tags and categories, and sorted into temporal groups, operational risk analysis module 26 may create a report in step 216 with the analyzed data. This report is communicated to computers 12 in step 218 and used in various instances. For example, the reports may be used to meet external regulatory expectations. Additionally, the reports may be used for applications internal to organization 11. For example, the reports may be used as input into other active risk analysis systems, such as key operational risk structured analysis and mapping processes, emerging operational risk identification and related scenario planning, vendor risk management, contingency and disaster recovery planning, competitor threat analysis, risk self assessment control reviews, initiative risk and change monitoring, and/or strategic planning and competitive threat analysis.

At step 220, operational risk analysis module 26 determines whether to restart the process. If the process begins again, the method continues from step 202, otherwise the method ends. Operational risk analysis module 26 may receive information from the various data sources continuously, and may implement the analysis process on a predetermined schedule. For example, operational risk analysis module 26 may perform the analysis on a quarterly basis, on a monthly basis, on a weekly basis, or during any predetermined time period.

Modifications, additions, or omissions may be made to method 200 depicted in FIG. 2. The method may include more, fewer, or other steps. Additionally, steps may be performed in parallel or in any suitable order. While discussed as operational risk analysis module 26 performing the steps, any suitable component of system 10 may perform one or more steps of the method.

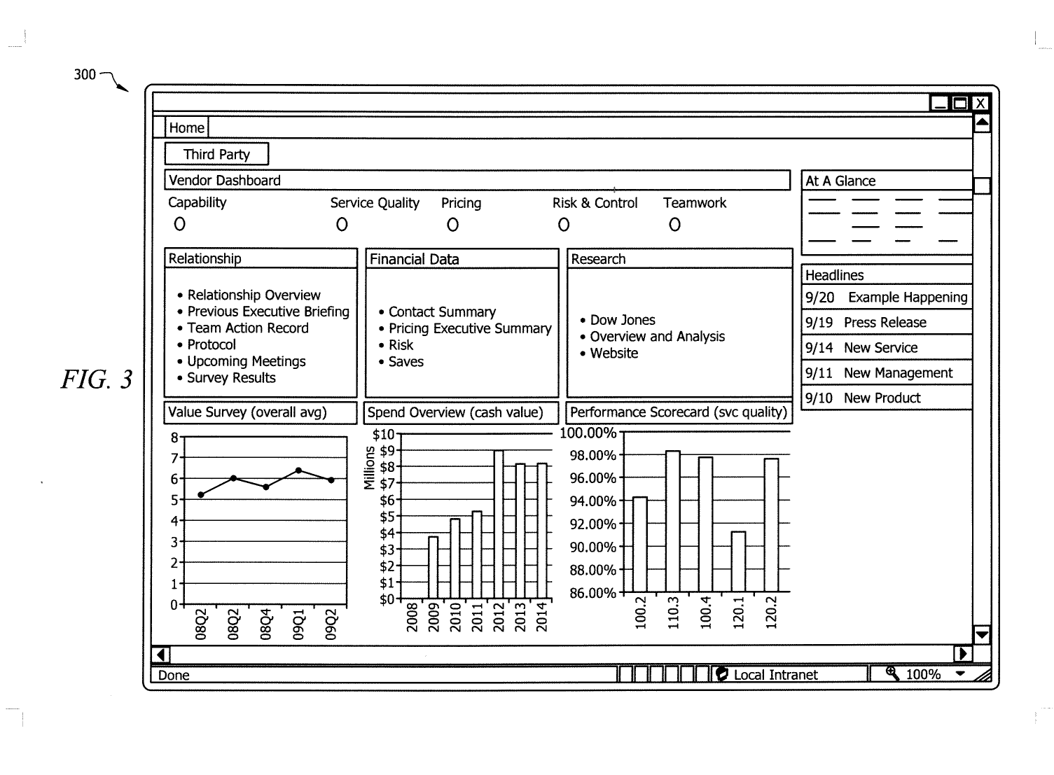

FIG. 3 illustrates a screenshot 300 that provides information regarding a third party gathered from an internal source. As discussed above, the organization may store information internally regarding third parties. This information may relate to competitors and/or vendors. The illustrated embodiment provides a graphical representation of the information related to a third party that the organization has compiled. Screenshot 300 includes information related to the relationship between the organization and the third party, financial data, research, headlines associated with the third party, and any other suitable information that the organization compiles. Modifications, additions, or omissions may be made to screenshot 300 without departing from the scope of the invention.

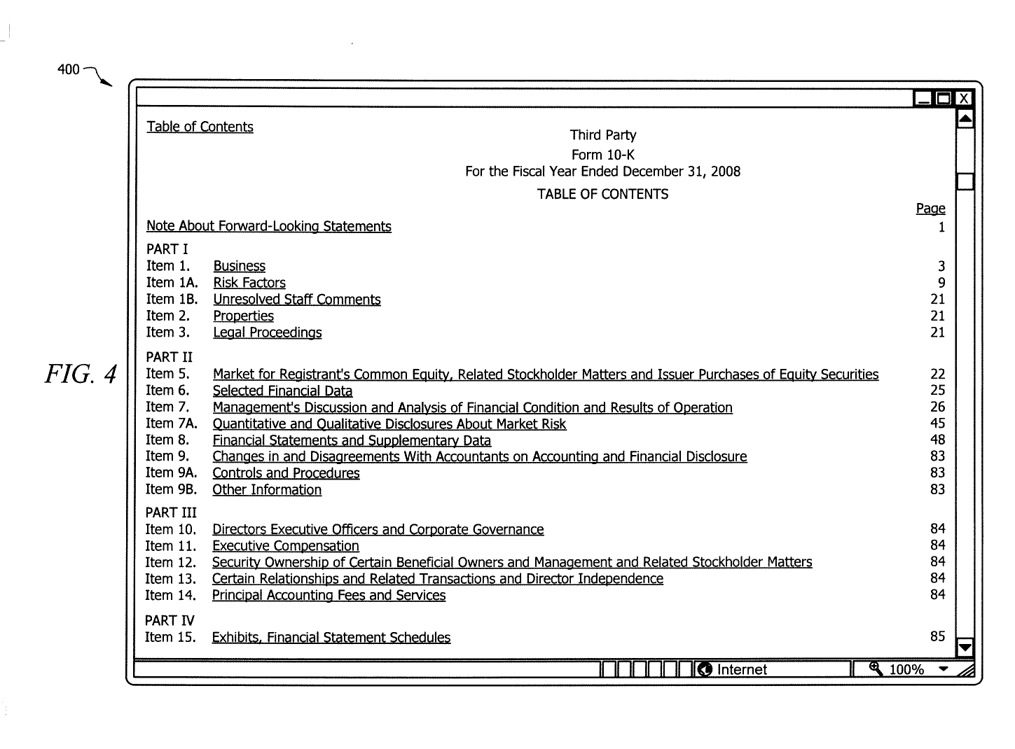

FIG. 4 illustrates a screenshot 400 that illustrates information regarding a third party gathered from a source external to the organization. As discussed above, organizational risk analysis module 26 may communicate with data sources 18 to compile unstructured data associated with third parties. Screenshot 400 illustrates example information that organizational risk analysis module 26 may receive from data source 18. The illustrated screenshot represents information associated with a third party's regulatory filing. Modifications, additions, or omissions may be made to screenshot 400 without departing from the scope of the invention.

Certain embodiments of the present disclosure may provide one or more technical advantages. A technical advantage of one embodiment includes providing a system that facilitates the analysis of unstructured operational risk data for organizations. Having the ability to analyze unstructured operational risk data allows for a broader risk analysis. Another technical advantage of an embodiment includes analyzing unstructured data that is internal to the organization and analyzing unstructured data that is external to the organization. Again, broadening the scope of the analysis allows the organization to better understand potential risks and respond accordingly. Yet another technical advantage includes electronically gathering information from electronic data sources to provide current information regarding the external organizations to provide more complete and accurate information for the risk analysis.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A system for capability development in an organization, comprising:
a network interface operable to:
receive data associated with an organization from at least one data source of a plurality of data sources over a network; and
receive data associated with a plurality of third parties from at least two data sources of the plurality of data sources over the network;
a processor communicatively coupled to the network interface and operable to:
categorize the organization data and the third party data according to operational risk categories and the operational risk categories comprise the following categories: fraud and criminal, human malicious external events, human non-malicious external events, natural events and disasters, third party and vendor, legal, and regulatory and governmental;
analyze the categorized organization data and the third party data and analyzing comprises applying a weighting factor to the categorized organization data and the third party data according to whether the categorized organization data and third party data is congruent across the plurality of data sources, wherein regulatory data is given a higher weighting factor; and
create a report based on the analysis, wherein the network interface is further operable to communicate the report to a computer.

2. The system of claim 1, wherein the data associated with a plurality of third parties comprises data associated with at least one of a competitor of the organization, a potential competitor of the organization, a collaborator of the organization, and a vendor of the organization.

3. The system of claim 1, wherein the data associated with the organization and the plurality of third parties comprises unstructured data.

4. The system of claim 1, wherein the processor is further operable to:
tag the categorized data with source information; and
compile the tagged and categorized data according to the source information.

5. (canceled)

6. The system of claim 1, wherein the processor is further operable to:
compile a first set of risks based on the data associated with the organization;
compile a second set of risks based on the data associated with the plurality of third parties, wherein the first set of risks and the second set of risks comprise different risks.

7. The system of claim 1, wherein the processor is further operable to sort the analyzed data into temporal groups.

8. Non-transitory computer readable medium comprising logic, the logic, when executed by a processor, operable to:
receive data associated with an organization from at least one data source of a plurality of data sources over a network;
receive data associated with a plurality of third parties from at least two data sources of the plurality of data sources over the network;
categorize the organization data and the third party data according to operational risk categories and the operational risk categories comprise the following categories: fraud and criminal, human malicious external events, human non-malicious external events, natural events and disasters, third party and vendor, legal, and regulatory and governmental;
analyze the categorized organization data and the third party data and analyzing comprises applying a weighting factor to the categorized organization data and the third party data according to whether the categorized organization data and third data is congruent across the plurality of data sources, wherein regulatory data is given a higher weighting factor;
create a report based on the analysis; and
communicate the report to a computer.

9. The computer readable medium of claim 8, wherein the data associated with the organization and the plurality of third parties comprises unstructured data.

10. The computer readable medium of claim 8, wherein the logic is further operable to:
tag the categorized data with source information; and
compile the tagged and categorized data according to the source information.

11. (canceled)

12. The computer readable medium of claim 8, wherein the logic is further operable to:
compile a first set of risks based on the data associated with the organization;
compile a second set of risks based on the data associated with the plurality of third parties, wherein the first set of risks and the second set of risks comprise different risks.

13. The computer readable medium of claim 8, wherein the logic is further operable to sort the analyzed data into temporal groups.

14. A method for external operational risk analysis, comprising:
receiving data associated with an organization from at least one data source of a plurality of data sources over a network;
receiving data associated with a plurality of third parties from at least two data sources of the plurality of data sources over the network;
categorizing, by a processor, the organization data and the third party data according to operational risk categories and the operational risk categories comprise the following categories: fraud and criminal, human malicious external events, human non-malicious external events, natural events and disasters, third party and vendor, legal, and regulatory and governmental;
analyzing, by the processor, the categorized organization data and the third party data and analyzing comprises applying a weighting factor to the categorized organization data and the third party data according to whether the categorized organization data and third party data is congruent across the plurality of data sources, wherein regulatory data is given a higher weighting factor;
creating a report based on the analysis; and
communicating the report to a computer.

15. The method of claim 14, wherein the data associated with a plurality of third parties comprises data associated with at least one of a competitor of the organization, a potential competitor of the organization, a collaborator of the organization, and a vendor of the organization.

16. The method of claim 14, wherein the data associated with the organization and the plurality of third parties comprises unstructured data.

17. The method of claim 14, further comprising:
tagging the categorized data with source information; and
compiling the tagged and categorized data according to the source information.

18. (canceled)

19. The method of claim 14, further comprising:
compiling a first set of risks based on the data associated with the organization;
compiling a second set of risks based on the data associated with the plurality of third parties, wherein the first set of risks and the second set of risks comprise different risks.

20. The method of claim 14, further comprising sorting the analyzed data into temporal groups.
